(19) United States
(12) Patent Application Publication
(10) Pub. No.: US 2002/0154509 A1
(43) Pub. Date: Oct. 24, 2002

(54) Collapsible lampshade

(76) Inventor: Michael R. Dene, Long Beach, CA (US)

Correspondence Address: KIRKPATRICK & LOCKHART LLP, 535 SMITHFIELD STREET, PITTSBURGH, PA, 15222, US

(21) Appl. No.: 09/838,658

(22) Filed: Apr. 19, 2001

(51) Int. Cl. F21V 17/00

(52) U.S. Cl. 362/450

(57) ABSTRACT

A frame for a collapsible lampshade. The frame includes an upper support member and a lower support member spaced apart from the upper support member, a shade spider having a central hub and a plurality of cross members extending radially from the central hub and a plurality of lampshade brackets. Each bracket includes a first elongated member and a second elongated member movably connected at an end thereof to the lower support member. The brackets further include a crossbar extending between and connected to another end of the first and second elongated members such that the crossbar is releasably engagable with the second end of the respective cross member of the shade spider in order to facilitate movement of the frame between a collapsed position and an upright position.

### CROSS-REFERENCE TO RELATED APPLICATIONS

Not applicable.

### FEDERALLY SPONSORED RESEARCH

Not applicable.

### BACKGROUND OF THE INVENTION

1. Field of the Invention

The invention relates to lampshades and, more particularly, to a frame for a collapsible lampshade.

2. Description of the Invention Background

Lampshades are well known items that are available in numerous sizes and shapes. Typically, lampshades are manufactured from a rigid or inflexible material such that the lampshade is manufactured or pre-assembled in generally the same configuration in which the lampshade will be utilized in association with a lamp. This type of lampshade is more costly for the manufacturer, wholesaler or retailer to store and/or ship because, essentially, of the size of the lampshade. In addition, the rigid or inflexible material from which this type of lampshade is made increases the likelihood of the lampshade being damaged or broken, particularly during shipment.

As an alternative, lampshades may be made that have a collapsible frame that can be placed in a substantially flat condition and that can be assembled for use. Such lampshades typically include a cover attached to the frame wherein the cover is made of a flexible or non-rigid material that will collapse with the frame and expand with the frame when assembled for use. For example, U. S. Pat. No. 5,375,048 discloses a collapsible lampshade that includes a shade spider that is moveably attached to a slide member mounted on rib members that extend between upper and lower supports of the lampshade. The lampshade includes numerous components that can be costly to manufacture, as well as, that increase the likelihood of one or more of the components becoming defective or not working properly during assembly and/or use thereof.

Other such collapsible lampshades include a plurality of individual rib members extending between upper and lower supports of the lampshade wherein an end of the rib members is pivotably attached to one of the upper or lower supports and another end of the rib members is removably connected to the other of the upper or lower supports for collapsing and assembling the lampshade. The use of the individual rib members connected at ends thereof to the upper and lower supports can result in twisting or skewing of either the upper or lower support with respect to the other support resulting in twisting or skewing of the lampshade or, more specifically, of the cover placed on the lampshade.

There remains, therefore, a need for an improved collapsible lampshade that overcomes limitations, shortcomings and disadvantages of known collapsible lampshades.

### SUMMARY OF THE INVENTION

The invention meets the identified needs, as well as other needs, as will be more fully understood following a review of this specification and drawings.

The invention, in one embodiment, includes a frame for a collapsible lampshade comprising an upper support member and a lower support member spaced apart from the upper support member, a shade spider and a plurality of lampshade brackets. The shade spider includes a central hub and a plurality of cross members extending radially from the central hub. Each of the cross members are attached at a first end to the central hub and at a second end to the upper support member. The plurality of lampshade brackets each comprise a first elongated member, a second elongated member and a crossbar extending therebetween. The first and second elongated members are movably connected at an end thereof to the lower support member and the crossbar extends between and is connected to another end of the first elongated member and another end of the second elongated member. The crossbar is releasably engagable with the second end of a respective cross member. Each of the lampshade brackets are movable between a first position and a second position such that movement of the lamp shade brackets to the first position causes the crossbar to be engaged with the second end of the cross member and the frame to be in an upright position. In addition, movement of the lampshade bracket to the second position causes the crossbar to be released from the second end of the cross member and the frame to be in a collapsible position.

In another embodiment, the invention includes a frame for a collapsible lampshade comprising an upper support member and a lower support member spaced apart from the upper support member, a central hub, a plurality of cross members extending radially from the central hub and a plurality of generally U-shaped brackets. Each cross member is attached at a first end to the central hub and at a second end to the upper support member. Each of the generally U-shaped brackets have an open end and a closed end such that said open end is movably connected to the lower support member and the closed end is releasably engagable with the second end of a respective cross member. Each of the generally U-shaped brackets is movable between a first position and a second position in order to place the frame in an upright position and a collapsible position.

In yet another embodiment, the invention includes a frame for a collapsible lampshade comprising an upper support member and a lower support member spaced apart from the upper support member, a plurality of hooks extending from the lower support member, a central hub, a plurality of cross members extending radially from the central hub and a plurality of generally U-shaped brackets. Each of the cross members is attached at a first end to the central hub and at a second end to the upper support member. The open end of the generally U-shaped brackets is releasably connected to at least one of the plurality of hooks for movement with respect thereto. The closed end of the generally U-shaped brackets is releasably engagable with the second end of a respective cross member. The open end of the generally U-shaped brackets being releasably connected to at least one of the plurality of hooks is particularly advantageous in a situation where the brackets have a length that is greater than a width or diameter of the lower support member.

### BRIEF DESCRIPTION OF THE DRAWING

In the accompanying drawings, there are shown embodiments of the invention wherein like reference numerals may be employed to designate like parts, and wherein:

FIG. 1 is a perspective view of one embodiment of a collapsible lampshade and specifically the frame thereof in accordance with the invention.

FIG. 2 is a perspective view similar to FIG. 1 illustrating a cover placed upon the frame to form the collapsible lampshade.

FIG. 3 is a bottom view of the collapsible lampshade illustrated in FIG. 2 shown in a collapsed position.

FIG. 4 is a bottom view similar to FIG. 3 showing the lampshade as being assembled to an upright position.

FIG. 5 is a partial cutaway view of the lampshade shown in FIG. 2 illustrating the lampshade as being assembled and/or collapsed.

FIG. 6 is a top view of an embodiment of a lampshade bracket used in accordance with the invention.

FIG. 7 is a front view of the lampshade bracket shown in FIG. 6.

FIG. 8 is a side view of the lampshade bracket shown in FIGS. 6 and 7.

FIGS. 9A and 9B are partial cutaway views showing the lampshade bracket of FIGS. 6-8 as attached to the frame of the lampshade shown in FIG. 1.

FIGS. 10A and 10B illustrate another embodiment of the invention with the lampshade bracket of FIGS. 6-8 as attached to the frame of a lampshade.

FIG. 11 is a perspective view of another embodiment of the invention illustrating a lampshade similar to that shown in FIG. 2.

FIG. 12 is a perspective view of another embodiment of a lampshade frame having a lampshade bracket removably connected thereto.

### DETAILED DESCRIPTION OF THE INVENTION

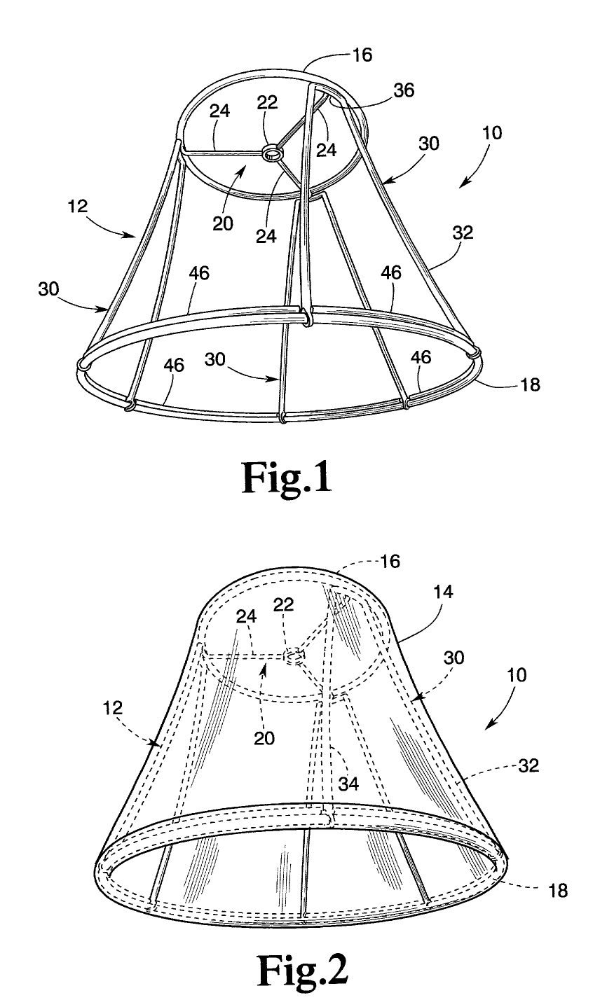

Referring now to the drawings for the purposes of illustrating embodiments of the invention only and not for purposes of limiting the same, there is shown a collapsible lampshade, generally designated by reference no. 10. FIG. 1 illustrates a frame, generally designated by reference no. 12, of the collapsible lampshade 10, while FIG. 2 illustrates the frame 12 with a lampshade cover 14 mounted thereto.

As best shown in FIG. 1, the frame 12 of the collapsible lampshade 10 includes an upper support member 16 and a lower support member 18 spaced apart from the upper support member 16. Preferably the support members 16 and 18 are spaced apart in generally parallel planes. As illustrated, the upper support member 16 and the lower support member 18 may be generally circular in shape, but it will be appreciated that other shapes and configurations may be employed for the upper support member 16 and the lower support member 18 to form a collapsible lampshade 10 of different shapes, sizes and configurations.

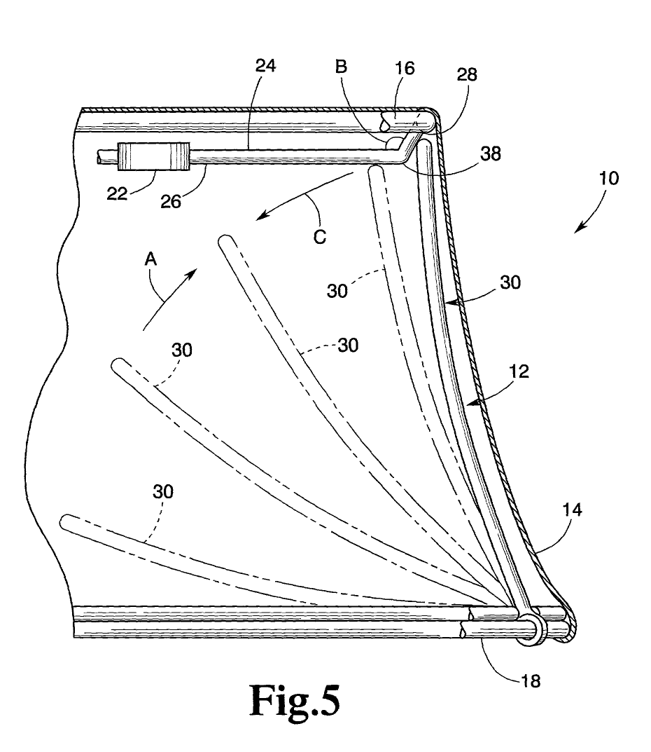

The frame 12 of the collapsible lampshade 10 also includes a shade spider, generally designated by reference no. 20. The shade spider 20 includes a central hub 22 and a plurality of cross members 24 that extend radially from the central hub 22. Each cross member 24 is attached at a first end 26 to the central hub 22 and at a second end 28 to the upper support member 16 (see FIG. 5).

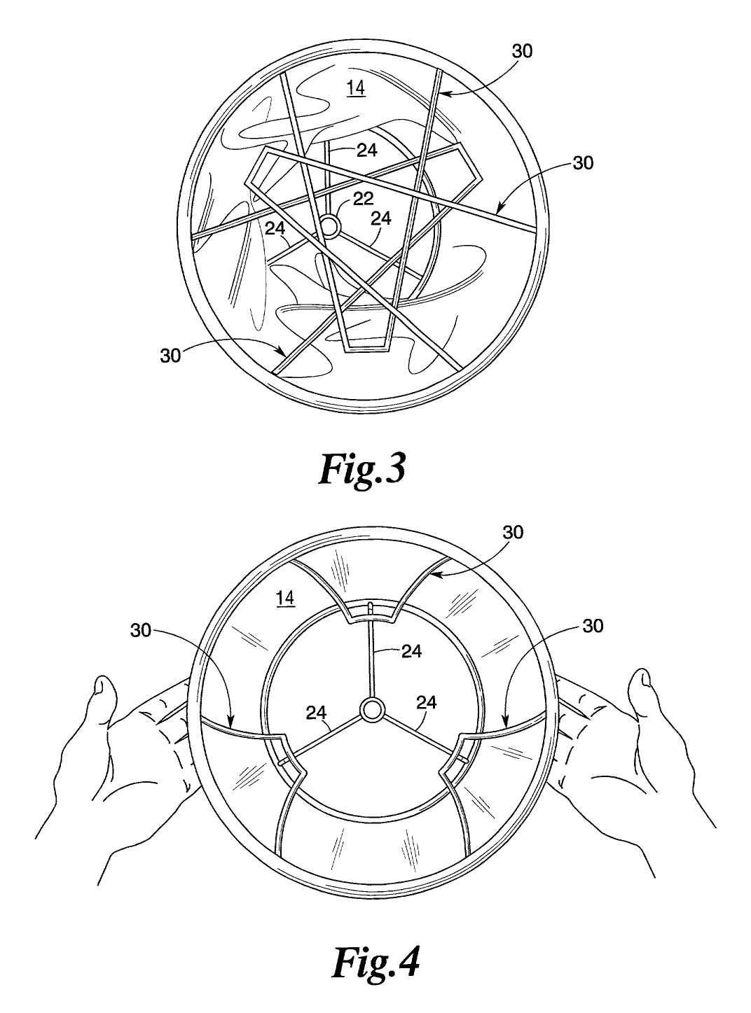

The frame 12 of the collapsible lampshade 10 also includes a plurality of lampshade brackets, generally designated by reference no. 30. As best shown in FIGS. 1 and 6-8, each bracket 30 is essentially identical in structure and function. Specifically, lampshade bracket 30 includes a first elongated member 32 and a second elongated member 34. The first elongated member 32 and the second elongated member 34 are each movably connected at an end thereof to a lower support member 18. At an opposing end of the lampshade bracket 30, a crossbar 36 extends between and is connected to the first elongated member 32 and the second elongated member 34. As will be explained in detail herein, the crossbar 36 is releasably engagable with the second end 28 of a respective cross member 24 in order to allow for movement of the lampshade bracket 30 to facilitate placement of the frame in an upright position, as shown in FIGS. 1-2, and a collapsible position, as shown in FIG. 3.

The brackets 30 may be generally U-shaped having an open end defined by the first elongated member 32 and the second elongated member 34 and a closed end opposite thereto formed by the crossbar 36. It will be appreciated, however, that the brackets 30 may have other shapes and configurations depending upon the particular size, shape and configuration of the collapsible lampshade 10 and the frame 12 in accordance with the invention. The brackets 30 may be formed of any suitable material having sufficient rigidity, such as metal, plastic or wood. In addition, the first elongated member 32, the second elongated member 34 and the crossbar 36 are preferably generally cylindrical-like components, although it will be appreciated that these components may be formed in other shapes and configurations for particular desired applications.

Referring to FIGS. 1-5, operation of the frame 12 to place the same in an upright position and a collapsible position will now be described in more detail. Specifically, when the collapsible lampshade 10, the frame 12 and attached cover 14 are in an upright position, as shown in FIG. 2, the lampshade brackets 30 are in a first position which results in the crossbar 36 of each of the lampshade brackets 30 being in engagement with the second end 28 of a respective cross member 24. While in an upright position, the cover 14, which may be constructed of any generally flexible or non-rigid material, such as, for example, a cloth-like material, is pulled into position about the upper support member 16 and the lower support member 18. As can be appreciated, the brackets 30 provide the structural support for maintaining the cover 14 in a desired position about the frame 12 in order to provide for use and operation of the cover 14. The cover may be attached to the support members 16 and 18 in a manner as is generally known in the art.

When the collapsible lampshade 10 and specifically the frame 12 thereof are in a collapsed position, as shown in FIG. 3, the lampshade brackets 30 are moved to a second position wherein the crossbar 36 is released from engagement with the second end 28 of the cross member 24. As shown in FIG. 3, when the brackets 30 are in the second position, the cover 14 and the upper support member 16 are allowed to collapse onto the top of the brackets 30 such that the lampshade 10 is in a substantially flat condition. Advantageously, this allows for the collapsible lampshade 10 to be easily boxed, stored or shipped while saving substantial space as opposed to the lampshade 10 being boxed, stored or shipped in the upright or assembled position.

Referring to FIGS. 4 and 5, movement of the frame between the collapsed position and the upright position is shown in more detail. Specifically, in FIG. 4 the lower support member 18 is lifted generally upward such that the brackets 30 are allowed to rotate about the lower support member 18 in the direction of arrow A, as shown in FIG. 5. The brackets 30 continue to rotate in the direction of arrow A until contact is made with the cross member 24 adjacent the second end 28 thereof. Specifically, the crossbar 36 engages the cross member 24 and pressure is applied thereto, still in the direction of arrow A until the crossbar 36 moves past the corner 38 that establishes the beginning of the second end 28 which extends at an angle from the remainder of the cross member 24. The frame 12 and the cover 14 are constructed and formed of materials that provide enough flexibility and resiliency to allow the crossbar 36 to be forced over the corner 38 for engagement with the second end 28 of the cross member 24. Preferably, the second end 28 is formed at an angle B, as shown in FIG. 5, with respect to the cross member 24 that extends from the central hub 22 of the shade spider 20. Preferably, the angle B is an obtuse angle in order to maintain the bracket 30, and more specifically the crossbar 36 thereof, in frictional engagement with the second end 28 to keep the frame 12 in an upright position.

Referring to FIG. 5, operation of the frame from the upright position to the collapsed position will be described in more detail. As described, the crossbar 36 of bracket 30 is in engagement with the second end 28 of the cross member 24 to maintain the frame 12 in an upright position. To collapse the frame 12 and move the same to a second or collapsed position, pressure is applied to the bracket 30 in order to move the crossbar 36 portion thereof past the corner 38 of the cross member 24. Once the crossbar 36 is moved past the corner 38 by applying pressure generally in the direction indicated by arrow C, the bracket 30 is allowed to freely move to the second or collapsed position. As described, this in turn allows for the upper support member 16, the shade spider 20 and the cover 14 to fall into a collapsed position thereby placing the collapsible lampshade 10 in a substantially flat condition. It will be appreciated that all brackets 30 operate in essentially the same manner.

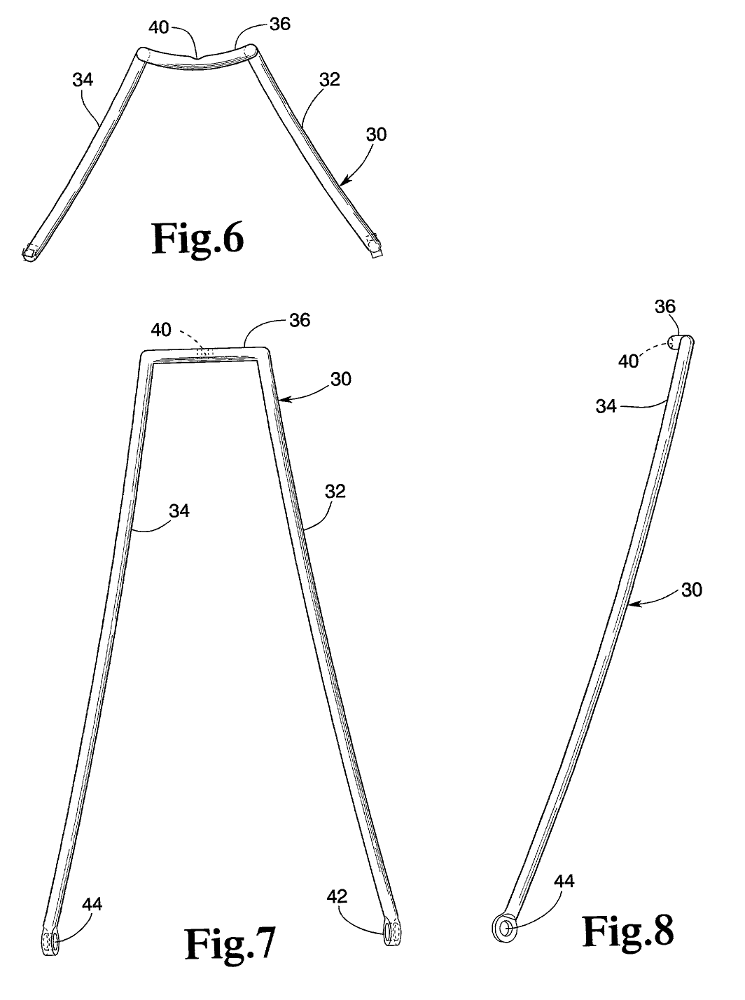

As shown in FIGS. 6-7, the crossbar 36 may include a depression 40 for receiving the cross member 24 and the second end 28 thereof. The depression 40 is preferably located at about a center point of the crossbar 36 to ensure that the bracket 30 is properly positioned with respect to the cross member 24 of the shade spider 20 to prevent, for example, undesired twisting or skewing of the frame 12.

As can be appreciated from the Figures, the crossbar 36 of the brackets 30 may have a shape that is generally complimentary to a shape of the upper support member 16. For example, the crossbar 36, as illustrated in FIG. 1, is generally arcuate in order that the crossbar 36 has a shape that is generally complimentary to the generally circular shape of the upper support member 16. This ensures cooperation between the crossbar 36 and the upper support member 16. It will be appreciated, that other shapes may be employed for the crossbar 36 and the upper support member 16.

Referring to FIG. 7, the first elongated member 32 of the bracket 30 includes a first aperture 42 adjacent the end of the first elongated member 32 that is movably connected to the lower support member 18. In addition, the second elongated member 34 includes a second aperture 44 adjacent an end thereof that is movably connected to the lower support member 18. The lower support member 18 extends through the apertures 42 and 44 to allow the bracket 30 to move thereabout. It will be appreciated that the apertures 42 and 44 may be of various shapes and configurations to allow movement of the brackets 30 about the lower support member 18.

Still referring to FIG. 7, the first aperture 42 is contained in a first plane that is unparallel to a second plane that contains the second aperture 44. This accommodates the apertures 42 and 44 being movably connected to the lower support member 18 when it has a generally circular shape, as shown in FIG. 1. The exact positioning of the first plane which contains the first aperture 42 with respect to the second plane that contains the second aperture 44 is determined, for example, according to the size, shape and configuration of the lower support member 18.

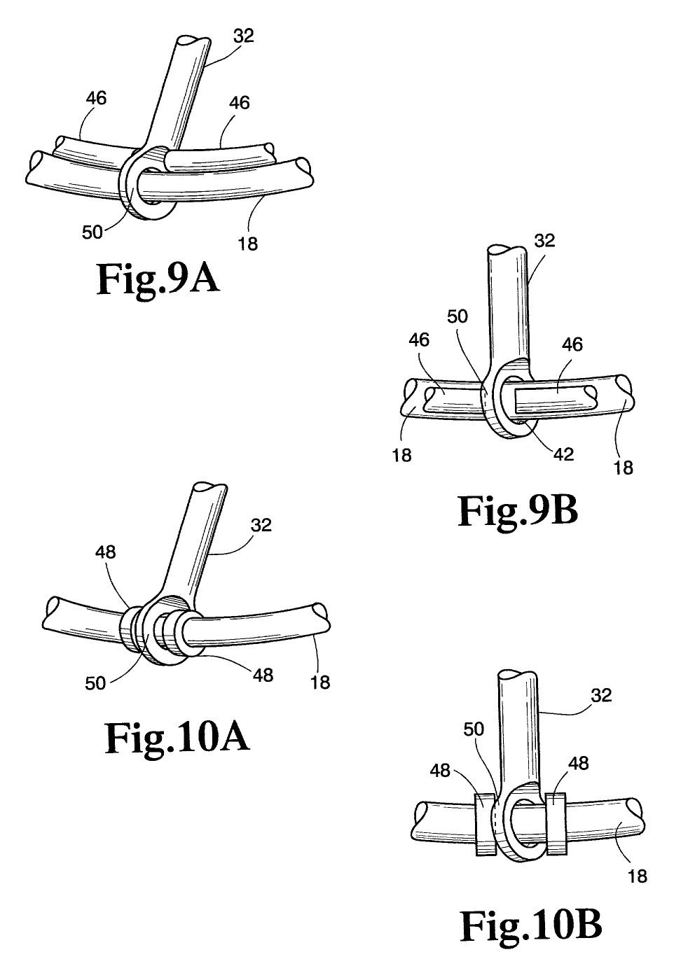

Referring to FIGS. 1, 9A and 10A, there is illustrated an additional aspect of the invention. Specifically, the frame 12 may include means for maintaining the ends of the first elongated member 32 and the second elongated member 34 at a desired position or location about or on the lower support member 18. In one embodiment (See for example FIG. 1 and 9A) a plurality of spacer bars 46 are positioned between the first elongated members 32 and the second elongated members 34, as well as between the plurality of brackets 30. Specifically, the spacer bars 46 may be attached to the lower support member 18 in a suitable manner, such as, for example, soldering or epoxy to attach the spacer bars 46 to the lower support member 18. The spacer bars 46 limit movement of members 32 and 34 along the length of member 18 and ensures that the brackets 30 are maintained in a desired position about the lower support member 18 and at a desired position in relation to the upper support member 16 and the shade spider 20 with which the brackets 30 cooperate for collapsing and assembling the collapsible lampshade 10, as described herein. FIG. 10A illustrates another embodiment where a set of stop members 48 may be attached to the lower support member 18 adjacent the first elongated member 32 to maintain the brackets 30 in a desired position, as well as adjacent member 34 (not shown).

Referring to FIGS. 9A, 9B, 10A and 10B, another aspect of the invention is illustrated. Specifically, the invention may include means for limiting movement of the lampshade brackets 30 past or beyond the second position when the frame 12 is collapsed. In one embodiment (see for example FIGS. 9A and 9B), movement of the first elongated member 32 from the described first position, as shown in FIG. 9A, to the described second position, as shown in FIG. 9B, results in a portion 50 of the first elongated member 32 adjacent the first aperture 42 engaging or contacting an end of the spacer bar 46. Similarly but not shown in the Figures, a portion of the second elongated member 34 adjacent the second aperture 44 also engages or contacts the spacer bar 46 to limit the movement of the second elongated member 34 past the second position. The portion 50 of the first elongated member 32 and the similar portion of the second elongated member 34 engage the spacer bar as a result of the configuration of the ends of the respective elongated members, as previously described wherein the first aperture 42 is contained in a first plane that is unparallel to a second plane containing the second aperture 44. Accordingly, it will be appreciated that the described and illustrated configuration allows for the first elongated member 32 and the second elongated member 34 to be moved between the described first and second positions, and that once in the second position to collapse the frame 12 of the lampshade 10, further movement of the brackets 30, and specifically further movement of the first elongated member 32 and the second elongated member 34, beyond the second position is limited or restricted.

FIGS. 10A and 10B illustrate another embodiment, similar to that described in FIGS. 9A and 9B wherein portion 50 engages at least one of the stop members 48 attached to the lower support member 18 to limit or restrict movement of the bracket 30, and specifically the first elongated member 32 and second elongated member thereof, past or beyond the second position.

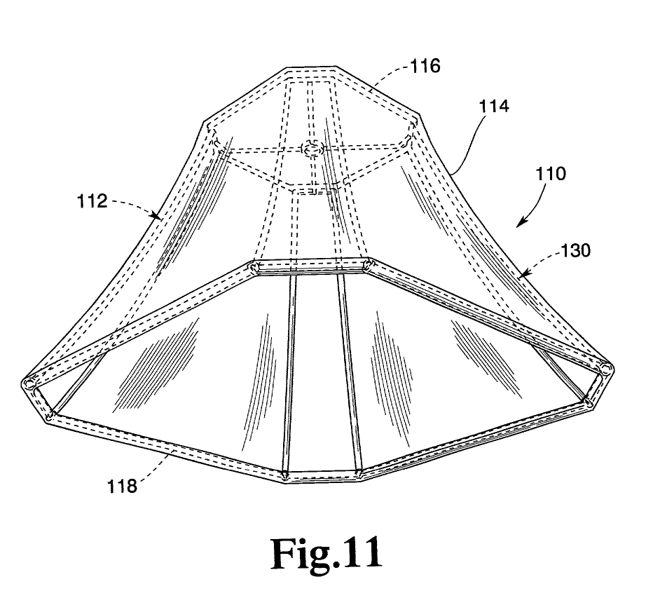

FIG. 11 illustrates another embodiment of the invention. Specifically, a collapsible lampshade 110 is similar in function and structure to the collapsible lampshade 10, as described and illustrated herein. The collapsible lampshade 110 includes a frame 112 having a cover 114 attached thereto. An upper support member 116 and lower support member 118 are configured in an other than circular configuration. Otherwise, a plurality of lampshade brackets 130 are provided that operate in essentially the same manner as the lampshade brackets 30 previously described herein.

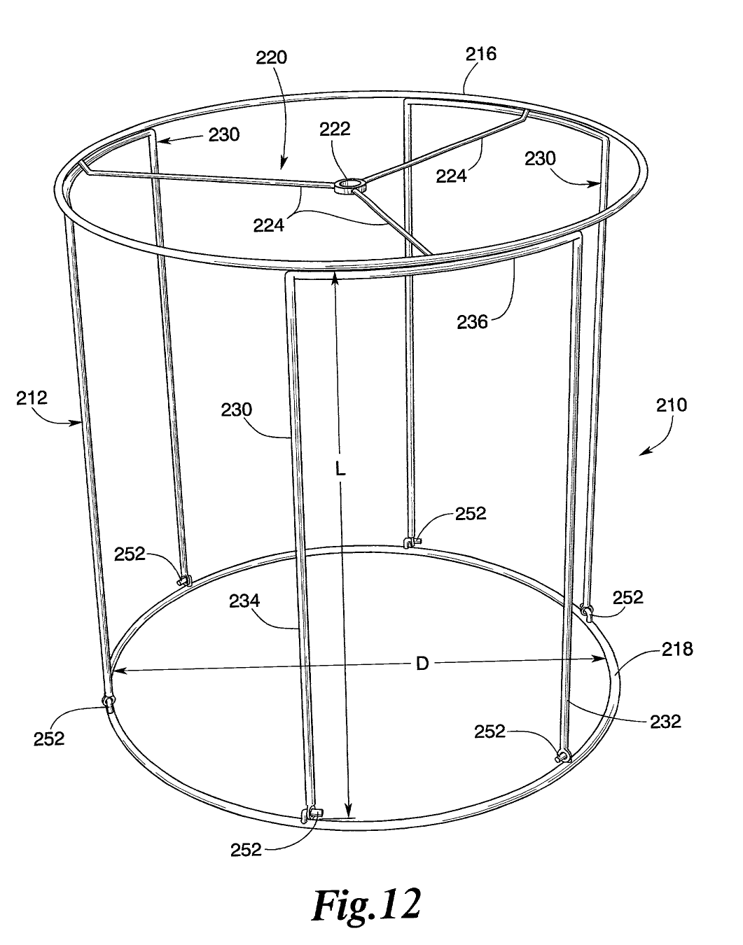

Referring to FIG. 12, there is illustrated an additional embodiment of the invention. Specifically, there is set forth a collapsible lampshade 210 having a frame, generally designated by reference no. 212, that includes an upper support member 216, a lower support member 218 and a plurality of lampshade brackets 230. Specifically, each lampshade bracket 230 includes a first elongated member 232, a second elongated member 234 and a crossbar 236, which defines a closed end of the bracket 230. The frame 212 further includes a plurality of hooks 252 extending from the lower support member 218. An end of the first elongated member 232 is attached to one of the hooks 252 and an end of the second elongated member 234 is also attached to one of the hooks 252. More specifically, the elongated members 232 and 234 are releasably connected to the hooks 252 for movement with respect thereto. The crossbar 236 operates in essentially the same manner as the crossbar 36, as described herein. However, it will be appreciated that in this embodiment the releasable connection of the brackets 230 to the hooks 252 which extend from the lower support member 218 is necessary when a length L of the brackets is greater than a width or diameter D of the lower support member. It will be further appreciated that when the length L of the bracket 230 is greater than the diameter D of the lower support member 218 that the bracket 230 is unable to be fully moved to the second position, as described herein for previous embodiments. Rather, the bracket 230 will contact a cover (not shown in FIG. 12) that is attached to the frame 212 preventing movement of the bracket 230 to the second position to allow the lampshade 210 to fully collapse. Accordingly, by disconnecting the brackets 230 from the hooks 252 and removing the brackets 230 from the frame 212 of the lampshade 210, the remaining portions of the lampshade 210 may be fully collapsed to a substantially flat condition.

Whereas particular embodiments of the invention have been described herein for the purpose of illustrating the invention and not for the purpose of limiting the same, it will be appreciated by those of ordinary skill in the art that numerous variations of the details, materials and arrangement of parts may be made within the principle and scope of the invention without departing from the invention as described in the appended claims.

What is claimed is:

1. A frame for a collapsible lampshade, comprising:
an upper support member;
a lower support member spaced apart from said upper support member;
a shade spider having a central hub and a plurality of cross members extending radially from said central hub, each said cross member being attached at a first end to said central hub and at a second end to said upper support member; and
a plurality of lampshade brackets, each said lampshade bracket comprising:
a first elongated member moveably connected at an end thereof to said lower support member;
a second elongated member moveably connected at an end thereof to said lower support member; and
a crossbar extending between and connected to another end of said first elongated member and another end of said second elongated member, said crossbar releasably engagable with said second end of a respective said cross member.

2. The frame of claim 1, wherein each said lampshade bracket is movable between a first position and a second position, movement of said lampshade bracket to said first position causes said crossbar to be engaged with said second end of said cross member and the frame to be in an upright position, and movement of said lampshade bracket to said second position causes said crossbar to be released from said second end of said cross member and the frame to be in a collapsible position.

3. The frame of claim 1, wherein said upper support member and said lower support member are spaced apart in generally parallel planes.

4. The frame of claim 1, wherein said second end of each said cross member extends at an obtuse angle from said cross member to facilitate said crossbar being releasably engagable with said second end.

5. The frame of claim 1, wherein said crossbar of each said lampshade bracket is generally arcuate.

6. The frame of claim 1, wherein said crossbar of each said lampshade bracket has a shape generally complimentary to a shape of said upper support member.

7. The frame of claim 6, wherein said shape of said upper support member is generally circular.

8. The frame of claim 1, wherein a shape of said lower support member is generally circular.

9. The frame of claim 1, wherein said crossbar includes a depression for receiving said cross member.

10. The frame of claim 9, wherein said depression is located at about a center point of said crossbar.

11. The frame of claim 1, further including means for maintaining the end of said first elongated member at a desired position on said lower support member.

12. The frame of claim 1, further including means for maintaining the end of said second elongated member at a desired position on said lower support member.

13. The frame of claim 2, further including means for limiting movement of said lampshade bracket past said second position.

14. The frame of claim 1, wherein the end of said first elongated member moveably connected to said lower support member defines a first aperture, said lower support member extending through said first aperture.

15. The frame of claim 14, wherein the end of said second elongated member moveably connected to said lower support member defines a second aperture, said lower support member extending through said second aperture.

16. The frame of claim 15, wherein said first aperture is contained in a first plane that is unparallel to a second plane that contains said second aperture.

17. The frame of claim 1, wherein said lower support member includes a plurality of hooks extending therefrom, said first elongated member and said second elongated member each moveably connected to one of said plurality of hooks.

18. The frame of claim 17, wherein said first elongated member and said second elongated member are each releasably connected to one of said plurality of hooks.

19. A frame for a collapsible lampshade, comprising:
an upper support member;
a lower support member spaced apart from said upper support member;
a central hub;
a plurality of cross members extending radially from said central hub, each said cross member being attached at a first end to said central hub and at a second end to said upper support member; and
a plurality of generally U-shaped brackets having an open end and a closed end, said open end moveably connected to said lower support member, said closed end releasably engagable with said second end of a respective said cross member.

20. The frame of claim 19, wherein each said bracket is movable between a first position and a second position, movement of said lampshade bracket to said first position causes said closed end to be engaged with said second end of said cross member and the frame to be in an upright position, and movement of said bracket to said second position causes said closed end to be released from said second end of said cross member and the frame to be in a collapsible position.

21. The frame of claim 19, wherein said upper support member and said lower support member are spaced apart in generally parallel planes.

22. The frame of claim 19, wherein said second end of each said cross member extends at an obtuse angle from said cross member to facilitate said closed end being releasably engagable with said second end.

23. The frame of claim 19, wherein said closed end of each said bracket is generally arcuate.

24. A frame for a collapsible lampshade, comprising:
an upper support member;
a lower support member spaced apart from said upper support member;
a plurality of hooks extending from said lower support member;
a central hub;
a plurality of cross members extending radially from said central hub, each said cross member being attached at a first end to said central hub and at a second end to said upper support member; and
a plurality of generally U-shaped brackets having an open end and a closed end, said open end releasably connected to said at least one of said plurality of hooks for movement with respect thereto, said closed end releasably engagable with said second end of a respective said cross member.

25. The frame of claim 24, wherein said each of said brackets has a length greater than a width of said lower support member.

26. The frame of claim 24, wherein said each of said brackets has a length greater than a diameter of said lower support member.

27. The frame of claim 24, wherein each said bracket is movable between a first position and a second position, movement of said lampshade bracket to said first position causes said closed end to be engaged with said second end of said cross member and the frame to be in an upright position, and movement of said bracket to said second position causes said closed end to be released from said second end of said cross member and the frame to be in a collapsible position.

28. The frame of claim 24, wherein said upper support member and said lower support member are spaced apart in generally parallel planes.

29. The frame of claim 24, wherein said second end of each said cross member extends at an obtuse angle from said cross member to facilitate said closed end being releasably engagable with said second end.
